(19) United States
(12) Patent Application Publication
(10) Pub. No.: US 2005/0089152 A1
(43) Pub. Date: Apr. 28, 2005

(54) Use charge displaying method and apparatus for a mobile communication terminal

(75) Inventor: Sang-Hyun Han, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/965,969

(22) Filed: Oct. 15, 2004

(30) Foreign Application Priority Data
Oct. 23, 2003 (KR) 10-2003-0074411

(51) Int. Cl. G06F 15/16

(52) U.S. Cl. 379/140

(57) ABSTRACT

A charge displaying method for a mobile communication terminal, the method comprising calculating a per-packet use charge for accessing a first content provided by a wireless data service, according to a predetermined billing rate; and adding the per-packet use charge for accessing the first content to prior use charges associated with the mobile communication terminal to determine a total use charge.

### CROSS-REFERENCE TO RELATED APPLICATIONS

Pursuant to 35 U.S.C. §119(a), this application claims the benefit of earlier filing date and right of priority to Korean Application No. 10-2003-0074411, filed on Oct. 23, 2003, the content of which is hereby incorporated by reference herein in its entirety.

### BACKGROUND OF THE INVENTION

1. Field of the Invention

The present invention relates to a portable communication terminal, and more particularly to a method of displaying usage charges for accessing content in real time.

2. Description of the Background Art

High-speed data transmission is now available in mobile communication networks. Thus, a user is able to easily access a variety of wireless services such as music, moving picture, game, etc. via a mobile communication terminal even while the user is traveling.

A service or usage charge for accessing the variety of wireless services may be billed per packet of data downloaded to the mobile communication terminal. In general, one packet can contain 512 bytes of data, i.e., about 0.5 k byte of data.

Instead of per packet billing, a timed method of billing may be implemented to charge a user for the time for accessing a wireless data service. In this method, the usage time includes the time required for accessing a web page, as well as the time required for a user to download the data. As such, a packet billing system in which a user is charged only for the downloaded data is more favorable over the timed method.

Further, the conventional mobile communication terminals that provide the usage time of a wireless data service, do not provide the user with information about the volume of data download. And, the user cannot know the associated service charge until the user receives a bill. Thus, a method and system is desirable that allows a user to view a charge associated with a data download, prior to the download being initiated, or while the download is in progress.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and Claims hereof as well as the appended drawings.

To achieve these and other advantages and in accordance with the purpose of the present invention, as embodied and broadly described, a charge displaying method for a mobile communication terminal is provided. The method comprises calculating a per-packet use charge for accessing a first content provided by a wireless data service, according to a predetermined billing rate; and adding the per-packet use charge for accessing the first content to prior use charges associated with the mobile communication terminal to determine a total use charge.

The method further comprises displaying the per-packet use charge for accessing the first content on a display section of the mobile communication terminal and displaying the total use charge on a section of the mobile communication terminal. A time frame is defined for the use charge to be displayed. In a preferred embodiment, the time frame is set in accordance with a user's instructions.

In accordance with one aspect of the invention, the per-packet charge is calculated based on a service category associated with a category of data accessed. The use charge is displayed for each category of data accessed. The use charge for each category is determined by a service provider and is stored in a memory of the mobile communication terminal, for example.

In an exemplary embodiment, the use charge is displayed on a display section of the mobile communication terminal at predetermined time intervals or is audibly announced via a speaker of the mobile communication terminal. The predetermined time intervals are set to a first value. The first value is set by a user of the mobile communication terminal.

In another embodiment, a charge displaying system for a mobile communication terminal comprises logic code for calculating a per-packet use charge for accessing a first content provided by a wireless data service, according to a predetermined billing rate; and logic code for the per-packet use charge for accessing the first content to prior use charges associated with the mobile communication terminal to determine a total use charge.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a display section of a mobile communication terminal embodying a charge displaying method according to a first embodiment of the present invention.

FIGS. 2A-2D illustrate a service management menu according to the first embodiment of the present invention.

FIG. 3 is a flow chart of a method of displaying usage charges for a mobile communication terminal according to one embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

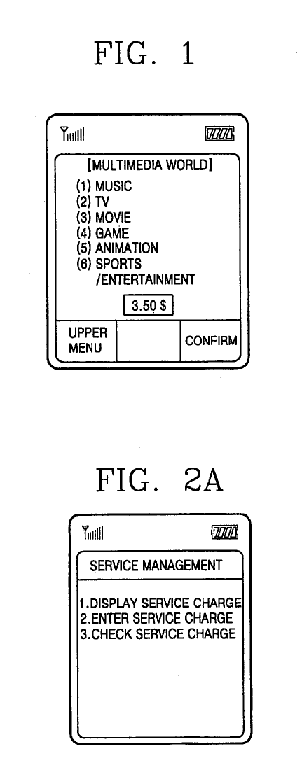

Referring to FIG. 1, a current service charge is displayed in the middle of the lower end of the display section of the mobile communication terminal. It should be noted that this embodiment is only an illustration and does not indicate that the current service charge is always displayed in the same position and in the same manner.

A current service charge may be displayed on the lower upper end or right lower end of the display section, for example. In one embodiment, the service charge may be expressed in voice each time a designated unit charge (for example, one dollar) is billed. For instance, a voice announcement such as “the current service charge is three dollar” may be outputted via a speaker to let a user to know the charge. Further, a variety of display methods may be set and changed by a user. The present invention provides a service management menu for allowing a user to easily set and change the displaying methods, in accordance with different embodiments.

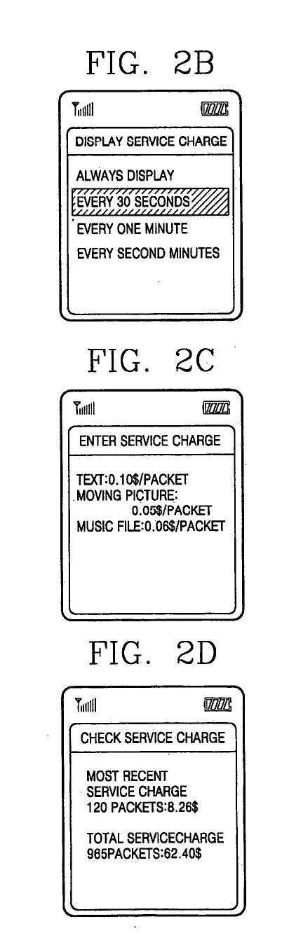

Referring to FIG. 2A, the service management menu may comprise, for example, lists such as ‘display service charge’, ‘enter service charge’ and ‘check service charge’. In the service management menu, if ‘display service charge’ is selected, for example, a screen as shown in FIG. 2B is displayed to enable a user to control a service charge feature that is always displayed on the display section of the mobile communication terminal or a service charge that is displayed at a predetermined time period.

That is, in FIG. 2B, if ‘always display’ category is selected, a service charge is continuously displayed during the use of a service. If “every 30 seconds’, ‘every one minute’ or ‘every second minutes’ category is selected, a service charge is respectively displayed every 30 seconds or every one minute or every second minutes. FIG. 2B illustrates an exemplary embodiment in which a status setting for ‘every 30 seconds’ is selected.

If ‘enter service charge’ is selected, for example, a screen as shown in FIG. 2C is displayed to enable the user to determine the billing rate for downloading various categories of data. For example, in FIG. 2C, text, moving picture and music file services are illustrated as having various billing rates. In an exemplary embodiment, the user enters a per-packet charge for the service corresponding to each data category.

In addition to the method in which the user directly reviewing or entering a per-packet charge, it is also possible for the user to determine the usage charges for more recent data download or a cumulative charge for all data downloaded from a specific point in time. As such, when ‘check service charge’ is selected, for example, as shown in FIG. 2D then a user will be able to check “most recent service charge’ and ‘total service charge’, for download data.

The most recent charge represents a service charge incurred when the user most recently connected to a wireless internet and used a service. The total charge represents the service charge incurred as accumulated from the beginning or from a reset point in time. The user can accumulate service charges to be incurred from a set point in time by resetting the total service charge to 0, for example.

If the mobile communication terminal receives one packet of data, a per-packet charge for a corresponding service is added to a previously calculate service charge (i.e., accumulated charge or total charge), thereby calculating a current service charge. In a preferred embodiment, the service charge is displayed in real time or according to a preset schedule determined based on user instructions. In another embodiment, when the wireless internet is disconnected, the current service charge is stored as the most recent charge in a memory and the current service charge is added to the total service charge and stored in the memory, for example.

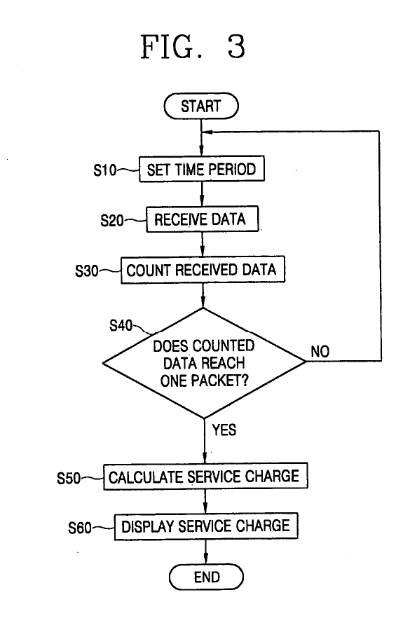

Referring to FIG. 3, in accordance with an exemplary embodiment of the invention, the user sets a charge displaying time period, using the management menu of the mobile communication terminal (S10). The setting does not need to be done each time. If the user uses a wireless data service without selecting the setting, the mobile communication terminal automatically uses the most recently set values and operates according to those values. The user can connect to a wireless Internet service using the mobile communication terminal, and then retrieve a desired service to receive data for a corresponding service like moving picture or music (S20).

When the mobile communication terminal begins to receive the data, the received data is counted per byte, for example, in a processor of the mobile communication terminal (S30). The mobile communication terminal determines whether or not the counted data equals one packet (S40). One packet is 512 bytes, i.e., about 0.5 kilobytes, and is generally the criteria of service charge estimation. If 512 bytes corresponding to one packet are not counted, the mobile communication terminal continues to receive data.

In an exemplary embodiment, when 512 bytes are counted, a per-packet charge for a corresponding service is added to the service charge, thereby calculating a current (i.e., real-time) service charge (S50). A previous charge is a service charge incurred before receiving a presently downloaded packet since initial connection to the wireless Internet. By adding the charge for the received packets to the previous service charge, it is possible to know the service charges incurred up to a particular time.

For example, in a case where a per-packet charge for a voice service is 0.1 dollar, where the previous service charge is 15.5 dollars, and when 512 bytes of data are received, the most recent service charge of 0.1 dollar and total service charge of 15.6 dollars is incurred and displayed. Thereafter, when another 512 bytes of data are received, the mobile communication terminal adds another charge of 0.1 dollar to the most recent service charge value, thereby displaying the current charge as 0.2 dollars.

The current service charge calculated is temporally stored in the memory of the mobile communication terminal and displayed on the display section, such as an LCD, of the mobile communication terminal (S60). In a preferred embodiment, the current service charge is displayed according to a time period set by the user or according to a value preset to the mobile communication terminal.

If the user sets a time period so that a service charge is displayed every three minutes, the mobile communication terminal displays a service charge every three minutes; if a time period is set to display a service charge every one minute, the service charge is displayed every one minute, for example. If a time period is set for the service charge to be always displayed, the service charge is displayed on the display section of the mobile communication terminal all the time the wireless data service is used.

In addition to the method of displaying a charge on the display section, a method of outputting a charge by voice announcement through a speaker section by a user's setting or selection is implemented in another embodiment. In the mobile communication terminal charge displaying method according to the present invention, the user can use a wireless data service by displaying the current service charge on the display section or informing the user of the current service charge by a voice output while the user is using the wireless data service by the mobile communication terminal.

By allowing the user to know a charge in real time, the method helps the user to have control over the amount billed or services used. Also, if by mistake an excessive charge is billed, the method enables the user to be able to check whether or not a service charge is actually correct since incurred charges are stored.

In a preferred embodiment, the charge displaying method for the mobile communication terminal according to the present invention does not require any hardware re-design and can be embodied in a conventional mobile communication terminal by downloading software and installing or modifying it. Accordingly, it is easy to apply and commercialize the method.

The embodiments described above are to be considered in all aspects as illustrative only and not restrictive in any manner. Thus, other exemplary embodiments, system architectures, platforms, and implementations that can support various aspects of the invention may be utilized without departing from the essential characteristics described herein. These and various other adaptations and combinations of features of the embodiments disclosed are within the scope of the invention. The invention is defined by the Claims and their full scope of equivalents.

1. A charge displaying method for a mobile communication terminal, the method comprising:
calculating a per-packet use charge for accessing a first content provided by a wireless data service, according to a predetermined billing rate; and
adding the per-packet use charge for accessing the first content to prior use charges associated with the mobile communication terminal to determine a total use charge.

2. The method of claim 1, further comprising displaying the per-packet use charge for accessing the first content on a display section of the mobile communication terminal.

3. The method of claim 1, further comprising displaying the total use charge on a display section of the mobile communication terminal.

4. The method of claim 2, further comprising defining a time frame for the use charge to be displayed.

5. The method of claim 4, wherein the time frame is set in accordance with a user's instructions.

6. The method of claim 1, wherein the per-packet charge is calculated based on a service category associated with a category of data accessed.

7. The method of claim 6, further comprising displaying the use charge for each category of data accessed.

8. The method of claim 7, wherein the use charge for each category is determined by a service provider.

9. The method of claim 1, further comprising storing the use charge in a memory of the mobile communication terminal.

10. The method of claim 1, wherein the use charge is displayed on a display section of the mobile communication terminal at predetermined time intervals.

11. The method of claim 1, wherein the use charge is audibly announced via a speaker of the mobile communication terminal.

12. The method of claim 10, wherein the predetermined time intervals are set to a first value.

13. The method of claim 12, wherein the first value is set by a user of the mobile communication terminal.

14. A charge displaying system for a mobile communication terminal, the system comprising:
logic code for calculating a per-packet use charge for accessing a first content provided by a wireless data service, according to a predetermined billing rate; and
logic code for the per-packet use charge for accessing the first content to prior use charges associated with the mobile communication terminal to determine a total use charge.

15. The system of claim 14, further comprising logic code for displaying the per-packet use charge for accessing the first content on a display section of the mobile communication terminal.

16. The system of claim 14, further comprising logic code for displaying the total use charge on a display section of the mobile communication terminal.

17. The system of claim 15, further comprising defining logic code for a time frame for the use charge to be displayed.

18. The system of claim 17, wherein the time frame is set in accordance with a user's instructions.

19. The system of claim 14, wherein the per-packet charge is calculated based on a service category associated with a category of data accessed.

20. The method of claim 19, further comprising logic code for displaying the use charge for each category of data accessed.
